(19) United States
(12) Patent Application Publication
(10) Pub. No.: US 2008/0197722 A1
(43) Pub. Date: Aug. 21, 2008

(54) Electric motor with a commutator-side rotor bearing

(75) Inventors: Helmut Burger, Moorenweis (DE); Jens Frenzel, Landsberg (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 12/069,612

(22) Filed: Feb. 11, 2008

(30) Foreign Application Priority Data
Feb. 16, 2007 (DE) 10 2007 000 097.0

(51) Int. Cl. H02K 5/24; H02K 7/14; H02K 5/14; H02K 5/16

(52) U.S. Cl. 310/50; 310/51; 310/90; 310/242; 310/233

(57) ABSTRACT

An electric motor has a housing (2) with a stator (3) and a rotor (5) located therein, a rotor bearing (4) for rotatably supporting a rotor shaft (6) around a rotor axis (A), a commutator (7), and a brush holder (8) with carbon brushes (9) associated with the stator (3) and fixed against rotation relative thereto, with the commutator-side rotor bearing (4) being fixedly connected to the brush holder (8) which is supported in a floating manner relative to the housing (2).

### BACKGROUND OF THE INVENTION

1. Field of the Invention

The invention relates to an electric motor with a commutator-side rotor bearing, particularly for use in at least partially percussive hand-held power tools such as, for example, chisel hammers or combination hammers.

2. Description of the Prior Art

Electric motors (universal motors) usually have a brush holder which is fixed with respect to the housing and a rotor which is fixed with respect to the housing, is axially preloaded, or is supported on the commutator side in a floating manner.

For example, in a universal motor of a hand-held power tool according to German Publication DE3346697 with a brush holder that is fixed with respect to the housing, the rotor shaft is floatingly supported on the commutator side by a needle bearing in a rubber cup. Accordingly, a needle bearing which is susceptible to deformation can also be used to support the rotor in hand-held power tools with a housing formed of two shell halves.

As a result of inertia, the vibrations, which are generated by the striking mechanism when used in at least partially percussive hand-held power tools cause relative movements between the commutator, which is arranged on the rotor shaft, and the brush holder with carbon brushes which is fixed with respect to the housing, so that slippage occurs therebetween which reduces output and shortens the life of the electric motor.

According to Japanese Publication JP2003289641, the brush holder is supported in a floating manner with respect to the housing by sleeve-shaped damping elements in order to prevent slippage between the commutator and the carbon brushes, but the rotor shaft is fixed with respect to the housing. However, slippage occurs when used in at least partially percussive hand-held power tools due to the inertia of the brush holder.

### SUMMARY OF THE INVENTION

It is the object of the invention to reduce the slippage between the commutator and the carbon brushes in an electric motor, particularly, when used in an at least partially percussive hand-held power tool.

This object and other objects of the present invention, which will become apparent hereinafter, are achieved by providing an electric motor having a housing, a stator, a rotor which has a rotor shaft and is supported in a rotor bearing for rotation around a rotor axis, and a commutator having a brush holder with carbon brushes and which is fixed to the stator. The commutator-side rotor bearing is fixedly connected with the brush holder and is floatingly supported relative to the housing.

The fixed connection of the rotor bearing with the brush holder prevents slippage between the commutator and the carbon brushes caused by inertia. However, because the rotor is supported on the commutator side, together with the brush holder, in a floating manner with respect to the housing, vibrations of the housing are sufficiently damped with respect to the rotor.

The commutator-side rotor bearing is advantageously arranged in a vibration-resistant bearing block which is rigid with respect to oscillation and, further advantageously, is made of an aluminum alloy and is fixedly connected to the brush holder and is floatingly supported with respect to the housing so that, practically, no relative oscillations occur between the rotor bearing and the brush holder.

The bearing block is advantageously connected to the housing by viscoelastic damping elements so that the bearing block is supported elastically and in a floating manner relative to the housing so as to be damped.

The damping elements are advantageously shaped as conical cups and receive within their interior associated conical pins of the housing and are themselves received in the interior of the bearing block in associated conical recesses so that the bearing block, which is supported in a floating manner radially and axially, can be fitted axial to the housing, providing for a simply designed assembly.

The conically cup-shaped damping elements advantageously have protuberances which are formed at their cup bases, so that elasticity is increased in axial direction.

Alternatively, the damping elements are advantageously sleeve-shaped and receive in their interior associated screws of the housing and are themselves received in associated recesses in the interior of the bearing block so that the bearing block, which is supported in a floating manner radially and axially, can be screwed axially to the housing, which also provides for a simply designed assembly.

The sleeve-shaped damping elements advantageously have a stiffening sleeve in their coaxial interior and are advantageously made of metal so that the screw connection can be compressively clamped.

The rotor shaft is advantageously compressively preloaded axially relative to the rotor bearing so that axial oscillations, which are caused by inertia, are prevented.

A viscoelastic O-ring is advantageously arranged between the bearing block and a bearing part of the rotor bearing. The bearing part is fixed against rotation, so that the rotor shaft which is compressively axially preloaded, is compressively preloaded against axial oscillations, being damped axially.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 an exploded view of an electric motor according to the present invention;

FIG. 2 a longitudinal cross-sectional view of FIG. 1;

FIG. 3 an exploded view of another embodiment of an electric motor according to the present invention; and

FIG. 4 a longitudinal cross-sectional view of a detail from FIG. 3.

### DETAILED DESCRIPTION OF THE PREFERRED EMBODIMENTS

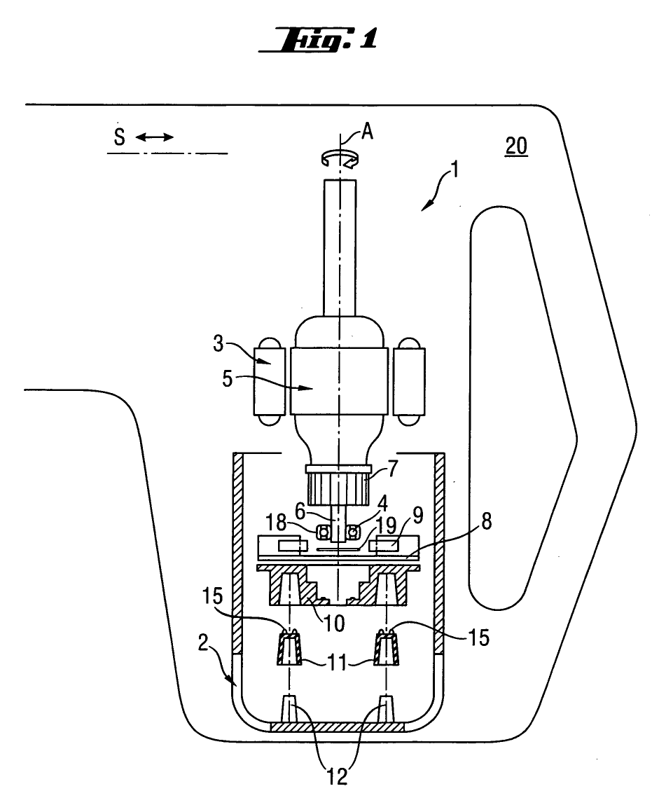

According to FIG. 1, an electric motor 1 according to the present invention, which is used in a hand-held power tool 20 which applies impacts along an impact axis S and which is shown only partially in an exploded view, has a housing 2, a stator 3 and a rotor 5 both located in the housing 2. The rotor 5 has a rotor shaft 6 and is rotatably supported for rotation around a rotor axis A by a rotor bearing 4. The electric motor 1 further includes a commutator 7. A brush holder 8 with carbon brushes 9 is associated with the stator 3 and is fixed against rotation relative thereto. The commutator-side rotor bearing 4 which is fixedly connected to the brush holder 8, is arranged in a vibration-resistant bearing block 10 and is made of an aluminum alloy. The bearing block 10 is floatingly connected to the housing 2 by viscoelastic damping elements 11. The rotor shaft 6 is compressively preloaded axially with respect to the rotor bearing 4 by a viscoelastic O-ring 19 arranged between the bearing block 10 and a bearing part 18 of the rotor bearing 4. The bearing part 18 is fixed against rotation relative to the bearing block 10.

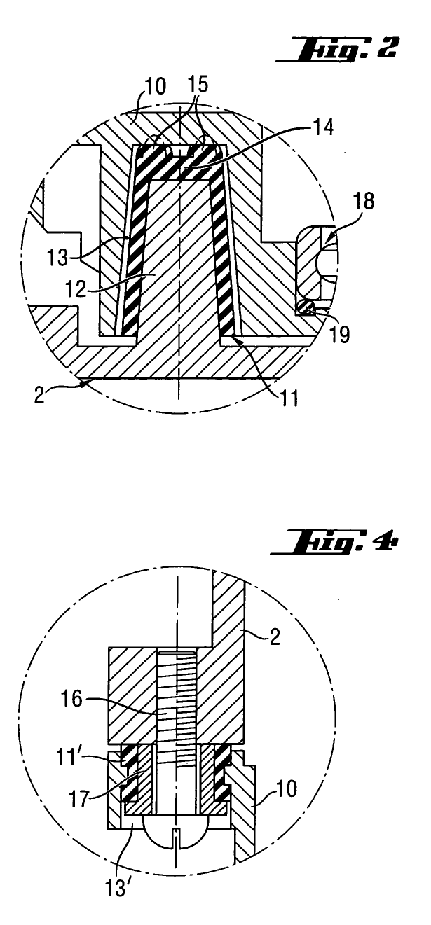

According to FIG. 2, the damping element 11 is formed as a conical cup and receives within its interior an associated conical pin 12 of the housing 2 and is itself received in the interior of the bearing block 10 in an associated conical recess 13. The conically cup-shaped damping element 11 has a plurality of protuberances 15 (shown in dashes in undeformed state) at its cup base 14.

A compressively clamped viscoelastic O-ring 19 is arranged between the bearing block 10 and the bearing part 18 that is fixed against rotation.

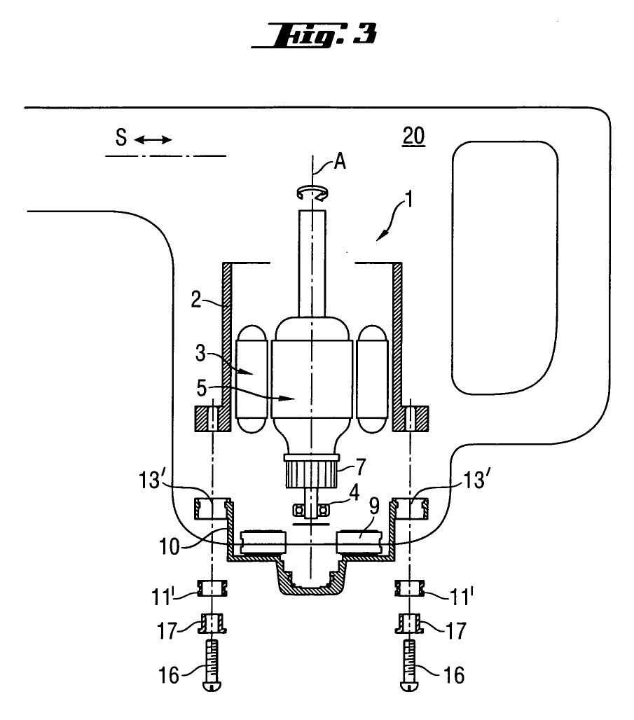

According to FIG. 3 and FIG. 4, the damping element 11′ is sleeve-shaped and receives, within its interior, an associated screw 16 of the housing 2 and is itself received in the interior of the bearing block 10 in an associated recess 13′. The sleeve-shaped damping element 11′ has a stiffening sleeve 17 of metal in its coaxial interior.

Though the present invention was shown and described with references to the preferred embodiments, such are merely illustrative of the present invention and are not to be construed as a limitation thereof, and various modifications of the present invention will be apparent to those skilled in the art. It is therefore not intended that the present invention be limited to the disclosed embodiments or details thereof, and the present invention includes all variations and/or alternative embodiments within the spirit and scope of the present invention as defined by the appended claims.

What is claimed is:

1. An electric motor comprising a housing (2); a stator (3) located in the housing (2); a rotor (5) having a rotor shaft (6) and located in the housing (2); a rotor bearing (4) for supporting the rotor shaft (6) for rotation around a rotor axis (A); a commutator (7); and a brush holder (8) with carbon brushes (9) associated with the stator (3) and fixed against rotation relative thereto, wherein the commutator-side rotor bearing (4) is fixedly connected with the brush holder (8) and is floatingly supported relative to the housing (2).

2. An electric motor according to claim 1, wherein the commutator-side rotor bearing (4) is arranged in a vibration-resistant bearing block ((10).

3. An electric motor according to claim 2, wherein the bearing block (10) is connected to the housing (2) by viscoelastic damping elements (11, 11′).

4. An electric motor according to claim 3, wherein the damping elements (11) are shaped as conical cups and receive within an interior thereof associated conical pins (12) of the housing (2) and are received in an interior of the bearing block (10) in associated conical recesses (13).

5. An electric motor according to claim 4, wherein the conically cup-shaped damping elements (11) have protuberances (15) which are formed at cup bases (14) thereof.

6. An electric motor according to claim 3, wherein the damping elements (11′) are sleeve-shaped and receive in an interior thereof associated screws (16) of the housing (2) and are themselves received in associated recesses (13′) in an interior of the bearing block (10).

7. An electric motor according to claim 6, wherein the sleeve-shaped damping elements (11′) each has a stiffening sleeve (17) located in an interior thereof coaxially with a respective element.

8. An electric motor according to one of claim 1, wherein the rotor shaft (6) is compressively preloaded axially relative to the rotor bearing (4).

9. An electric motor according to claim 8, wherein a viscoelastic O-ring (19) is arranged between the bearing block (10) and a bearing part (18) of the rotor bearing (4) and which is fixed against rotation relative to the bearing block (10).

10. An at least partially percussive hand-held power tool, comprising an electric motor for driving a percussion mechanism of the power tool and including a housing (2), a stator (3) located in the housing (2), a rotor (5) having a rotor shaft (6) and located in the housing (2), a rotor bearing (4) for supporting the rotor shaft (6) for rotation around a rotor axis (A), a commutator (7), and a brush holder (8) with carbon brushes (9) associated with the stator (3) and fixed against rotation relative thereto, wherein the commutator-side rotor bearing (4) is fixedly connected with the brush holder (8) and is floatingly supported relative to the housing (2).
